(19) United States
(12) Patent Application Publication
(10) Pub. No.: US 2022/0064041 A1
(43) Pub. Date: Mar. 3, 2022

(54) Blackwater Treatment

(71) Applicant: Hall Labs LLC, Provo, UT (US)

(72) Inventors: Michael Hall, Provo, UT (US); David R. Hall, Provo, UT (US); Prabhakar Ramaraj, Provo, UT (US); Carson Richards, Springville, UT (US); Nathan Davis, Bountiful, UT (US)

(73) Assignee: Hall Labs LLC, Provo, UT (US)

(21) Appl. No.: 17/460,525

(22) Filed: Aug. 30, 2021

Related U.S. Application Data
(60) Provisional application No. 63/072,755, filed on Aug. 31, 2020.

(51) Int. Cl. C02F 9/00

(52) U.S. Cl. CPC C02F 9/005; C02F 11/10

(57) ABSTRACT

Methods and system for treating blackwater are disclosed. A pyrolysis chamber and a condensing heat exchanger are provided. A blackwater slurry, consisting of blackwater solids, water, and volatiles, is passed into the pyrolysis chamber. The blackwater slurry is heated to produce steam, to separate at least a portion of the volatiles, and pyrolyze the blackwater solids, the separated volatiles passing out of the pyrolysis chamber. The steam and separated volatiles are cooled in a condensing heat exchanger, condensing at least a portion of the steam and at least a portion of the separated volatiles as a contaminated water stream. A water-clarifying chemical is added into the contaminated water stream that reacts with the volatiles, resulting in a treated water stream.

### CROSS-REFERENCE TO RELATED APPLICATIONS

This application claims priority to U.S. Provisional Patent Application 63/072,755 filed Aug. 31, 2020, the entire contents of which are incorporated herein by reference.

### TECHNICAL FIELD

This invention relates generally to treatment of blackwater.

### BACKGROUND

The Blackwater produced in most population centers is typically treated at a central facility in large quantities. Treatment of small amounts of blackwater in remote locations, and thus in small quantities, is difficult and not often addressed.

One application where treatment of small amounts of blackwater would be especially beneficial would be for mobile applications, such as recreational vehicles (RV's). Currently, the typically RV merely has a tank for storing blackwater generated on the RV. Depending on its capacity and the amount of blackwater generated, this tank must be periodically emptied and flushed, sometimes as frequently as every few days. If, instead, there was a workable system for treating the Blackwater generated on an RV, this unpleasant, inefficient or sometimes expensive process could be reduced or even eliminated. Such a system on an RV would also allow the RV to travel more freely, unconstrained by the need to find dumping stations.

### SUMMARY

In a first aspect, the disclosure provides a method for treating blackwater. A pyrolysis chamber and a condensing heat exchanger are provided. A blackwater slurry, consisting of blackwater solids, water, and volatiles, is passed into the pyrolysis chamber. The blackwater slurry is heated to produce steam, to separate at least a portion of the volatiles, and to pyrolyze the blackwater solids, the steam and the separated volatiles passing out of the pyrolysis chamber. The steam and separated volatiles are cooled in a condensing heat exchanger, condensing at least a portion of the steam and at least a portion of the separated volatiles as a contaminated water stream. A water-clarifying chemical is added into the contaminated water stream that reacts with the volatiles, resulting in a treated water stream.

In a second aspect, the disclosure provides a system for treating blackwater. A pyrolysis chamber is configured to receive a blackwater slurry, consisting of blackwater solids, water, and volatiles. The pyrolysis chamber is further configured to heat the blackwater slurry, thereby producing steam, separating at least a portion of the volatiles, and pyrolyzing the blackwater solids, passing the steam and the separated volatiles out of the pyrolysis chamber. A condensing heat exchanger is configured to receive the steam and separated volatiles and condense the steam and at least a portion of the separated volatiles as a contaminated water stream. The condensing heat exchanger is further configured to add a water-clarifying chemical into the contaminated water stream. The water-clarifying chemical reacts with the separated volatiles, resulting in a treated water stream.

In a third aspect, the disclosure provides a system for treating blackwater. A pyrolysis chamber is configured to receive a blackwater slurry, comprising blackwater solids, water, and volatiles. The pyrolysis chamber is further configured to heat the blackwater slurry, thereby producing steam, and pyrolyzing the blackwater solids, passing the steam out of the pyrolysis chamber. A condensing heat exchanger is configured to receive the steam and condense the steam. The pyrolysis chamber is configured to heat the slurry to evaporate the water in the slurry passing the water into the condensing heat exchanger. Once the steam has passed into the condensing heat exchanger, the slurry is further heated, and volatiles are separated from the slurry, and the separated volatiles are sent to the burner to be burned with the fuel heating the pyrolysis chamber.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a block diagram of a method for treating blackwater.

FIG. 2 is a top view of a system for treating blackwater.

FIG. 3 is a bottom view of the system of FIG. 2.

FIG. 4 is an isometric top front view of the system of FIG. 2.

FIG. 5 is an isometric top back view of the system of FIG. 2.

FIG. 6 is an isometric bottom side view of the system of FIG. 2.

FIG. 7 is an RV containing the system of FIG. 2.

FIG. 8 is a block diagram of a method for treating blackwater.

FIG. 9 is a block diagram of a method for treating blackwater.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “blackwater” is meant to refer to waste consisting of solids, liquids, and volatiles, organic and/or inorganic. This may include water, urine, feces, paper products, or combinations thereof. Typically, blackwater is the flush water from a toilet or urinal, mixed with the human waste deposited therein.

As used herein, “pyrolysis” is meant to refer to the thermal decomposition of materials at elevated temperatures in an inert atmosphere. Pyrolysis is typically used in breaking down organic materials. Due to the lack of oxygen, the material does not combust, instead, the chemical compounds decompose into gasses and char, or charcoal.

As used herein, “pyrolysis chamber” is meant to refer to the container where pyrolysis occurs. A typical pyrolysis chamber is made of two sealable chambers, an outer chamber or combustor and an inner chamber or a reactor. The inner chamber is where the organic material is deposited and pyrolyzed. The outer chamber is the combustor, the heat source, typically a burner such as a propane burner.

The volatiles in blackwater are meant to refer to at least, but not limited to, the following compounds and classes of compounds: methane, hydrogen sulfide, thiols, thionates, aldehydes, ketones, esters, carboxylic acids, aromatics, fatty acids, alcohols, and combinations thereof.

Blackwater treatment for small quantities and in remote locations is desirable. The sources include the toilets and urinals in recreational vehicles, house boats, campsite bathroom facilities, isolated villages, and industrial sites, among many others. Typically, small quantities are simply stored until storage capacity is full. At that point, the blackwater is either carried out and delivered to treatment centers (as in recreational vehicles) or is pumped into trucks and delivered to treatment centers (as in outhouses). Rather than carry out the waste, the present application discloses methods and systems for treatment of blackwater. Blackwater consists of a liquid component (mostly water), volatiles, and a solid component (mostly fecal matter), as defined above. Blackwater is passed into a pyrolysis chamber where it is heated to drive off water, as steam, and a portion of the volatiles. The leftover solids are further heated such that they are pyrolyzed, resulting in a char and further volatiles. The steam and separated or liberated volatiles are passed into a condensing heat exchanger and treated with a water-clarifying chemical, such as ozone, chlorine gas, or others defined below. The resultant water may then be recycled as flush water for the toilets producing the blackwater. Preferably, the char is vacuumed out of the pyrolysis chamber upon completion of pyrolysis. Alternatively, the char is collected as a solid or a pile of powder and used as fuel, such as a cooking fuel.

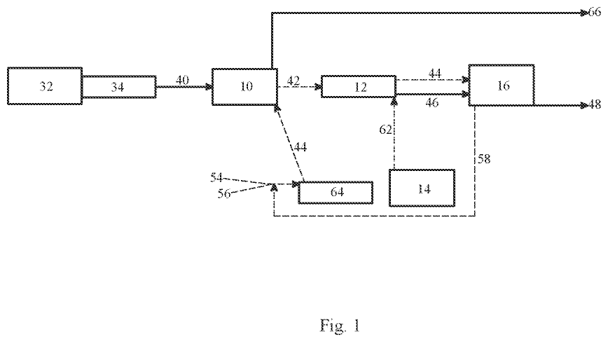

Now referring to FIG. 1, FIG. 1 is a block diagram of a method for treating blackwater that may be used in one embodiment of the present invention. A blackwater slurry 40 is stored in a blackwater tank 32 and is pumped from the blackwater tank, preferably by a macerator pump 34 into a pyrolysis chamber 10. A macerator pump can be used to comminute the solids, thereby increasing the surface area and flowability of the slurry. The blackwater slurry 40 consists of blackwater solids, water, and volatiles. The pyrolysis chamber 10 is heated by combustion flames 44 produced by a burner 64, the burner 64 burning propane 54 with air 56 and leftover fumes 58. The heat boils off water as steam and separates or liberates at least a portion of the volatiles, leaving dry blackwater solids in the pyrolysis chamber 10. The blackwater solids are further heated until they are pyrolyzed into a char 66 that is intermittently vacuumed out of the pyrolysis chamber 10. The pyrolysis separates further volatiles, and the combined steam and separated volatiles leave as stream 42. A condensing heat exchanger 12 cools the stream 42 so that the steam and at least a portion of the separated volatiles condense. An ozone generator 14 feeds ozone 62 into the condensing heat exchanger 12. Preferably, conventional ozone generators, i.e., those that use electricity to convert atmospheric O₂ to O₃, are used. The ozone acts as a water-clarifying chemical that destroys the separated volatiles, thereby removing odor-causing compounds and clarifying the water so that it is clear and not colored. The resultant clarified water stream 46 and any leftover volatiles and ozone 44 are passed from the condensing heat exchanger 12 into a holding tank 16. Any leftover separated volatiles and excess ozone are recycled as leftover fumes 58 to the burner 64 for destruction. The water in the holding tank 16 may be used as flush water for a toilet feeding the blackwater tank 32.

In another embodiment, instead of using an ozone generator, a chlorine gas generator is used, with the chlorine gas replacing the ozone stream.

In yet other embodiments, the ozone generator is replaced by a chemical feed system that passes a chemical into the condensing heat exchanger, which is effective in clarifying the waste stream. Preferably, the chemical used is selected from the group consisting of trichloro-s-triazinetrione, sodium hypochlorite, calcium hypochlorite, lithium hypochlorite, chlorinated isocyanurates, and hypochlorous acid.

In some embodiments, the volatiles are compounds selected from the group consisting of methane, hydrogen sulfide, thiols, thionates, aldehydes, ketones, esters, carboxylic acids, aromatics, fatty acids, alcohols, and combinations thereof.

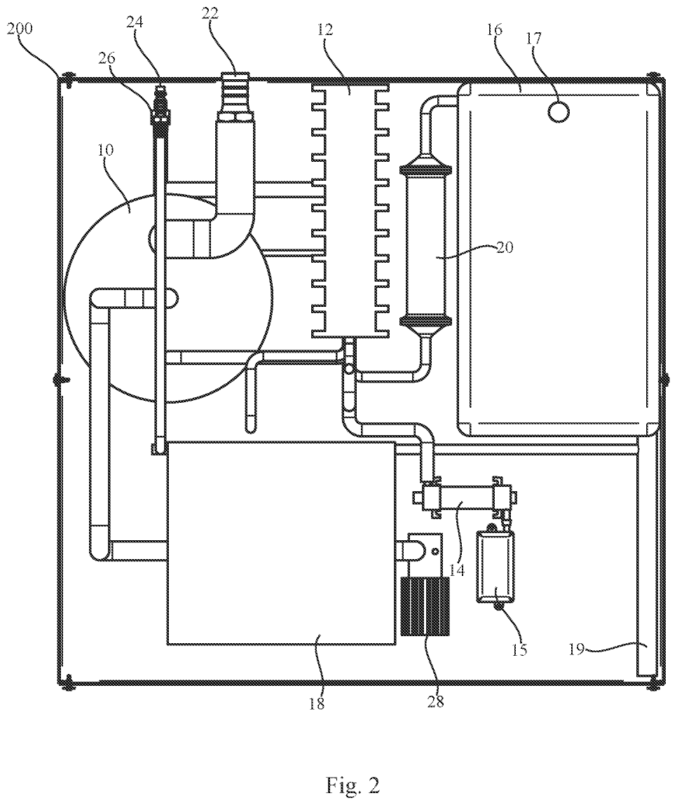

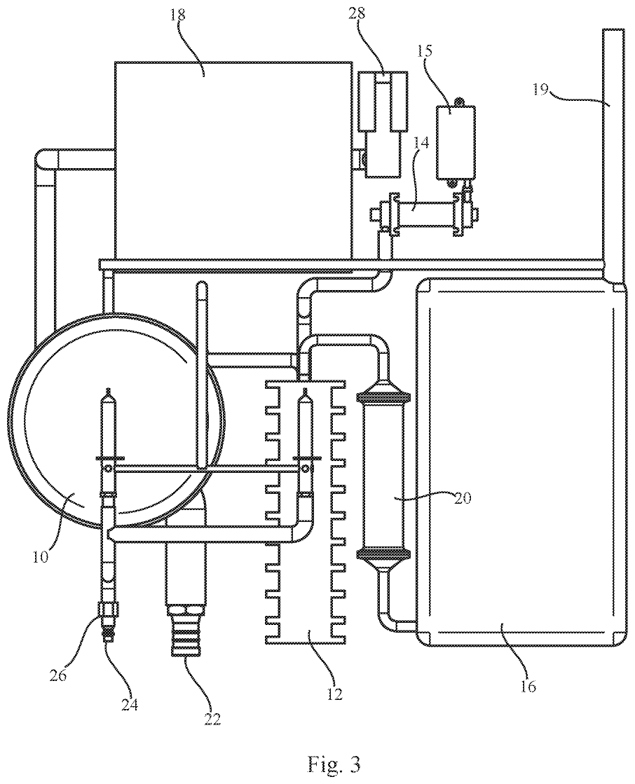

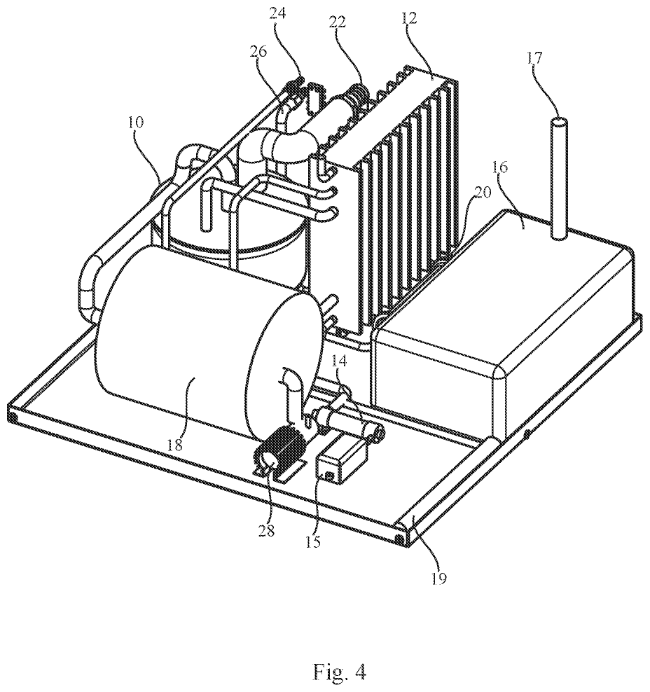

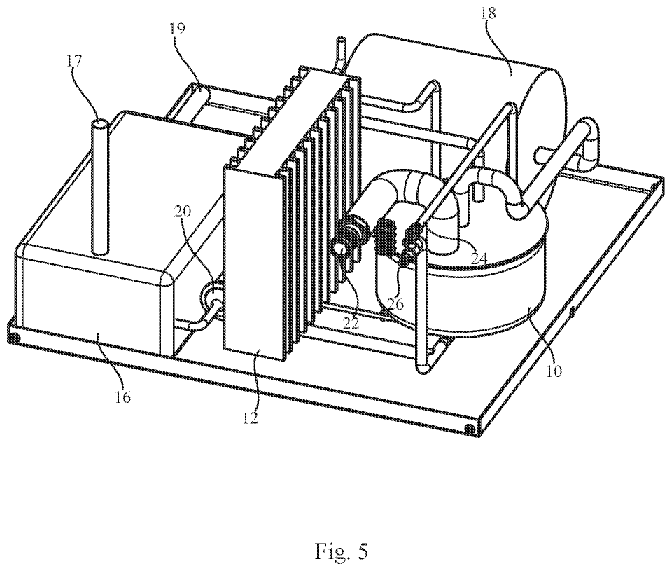

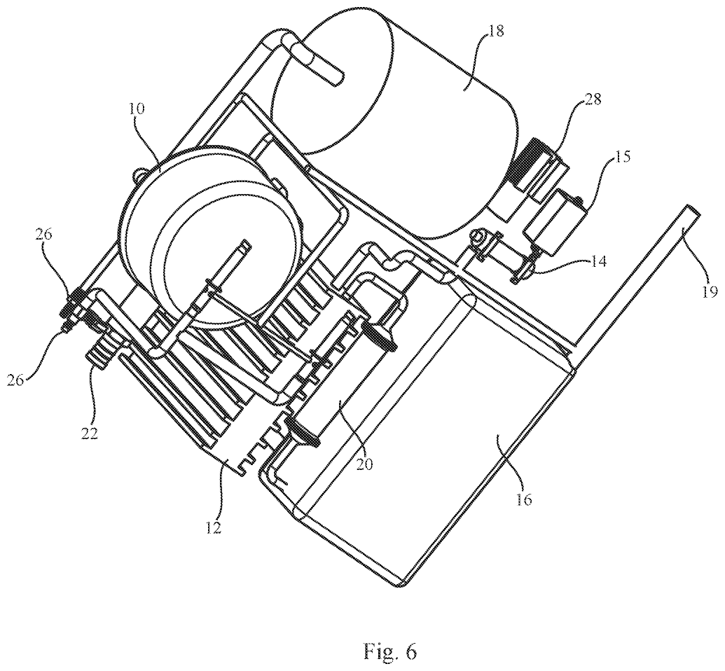

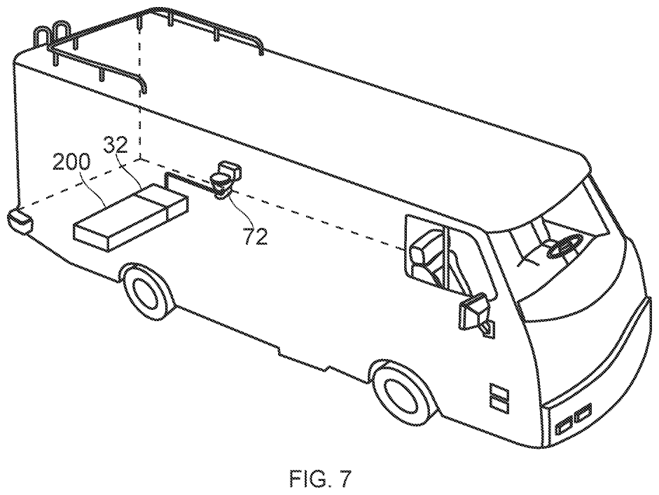

FIG. 2 is a top view of a system for treating blackwater that may be used in one embodiment of the present invention. FIG. 3 is a bottom view of the system of FIG. 2. FIG. 4 is an isometric top front view of the system of FIG. 2. FIG. 5 is an isometric top back view of the system of FIG. 2. FIG. 6 is an isometric bottom side view of the system of FIG. 2. In a preferred embodiment, this system 200 is located in an RV, as shown in FIG. 7. The system consists of a blackwater slurry inlet 22, a pyrolysis chamber 10, a char storage chamber 18, a condensing heat exchanger 12, a propane inlet 26, a flush water tank 16, a carbon filter 20, an ozone generator 14 with power supply 15, and a vacuum pump 28. The flush water tank 16 has a vent 17, a drain 19, and a flush water outlet 24.

The blackwater slurry is passed from a blackwater tank 32 (as in FIG. 7) through blackwater inlet 22 into the pyrolysis chamber 10, which is configured to receive the blackwater slurry. The pyrolysis chamber 10 receives propane fuel through the propane inlet 26, which it burns to heat the blackwater slurry. Heating produces steam and separates a portion of the volatiles, dehydrating the blackwater slurry and leaving the blackwater solids in the pyrolysis chamber. Further heating pyrolyzes the blackwater solids, producing further volatiles and resulting in a char. The steam and the combined separated volatiles pass from the pyrolysis chamber 10 into the condensing heat exchanger 12 where the steam and the separated volatiles are condensed as a contaminated water stream.

The ozone generator 14 passes ozone into the condensing heat exchanger 12. The ozone reacts with the separated volatiles, destroying odor-producing compounds and acting as a water clarifier, destroying compounds that discolor the water. The clarified water is passed through the carbon filter 20 into the flush water tank 16. The flush water tank 16 passes water to toilets for use as flush water. The char is vacuumed out of the pyrolysis chamber 10 and into the char storage chamber 18 by vacuum pump 28.

In the depicted embodiment, the pyrolysis chamber 10 is configured to operate in batches. The initial batch produces an initial amount of char that is left in the pyrolysis chamber. The next batch adds blackwater slurry to the pyrolysis chamber and the process is repeated, leaving behind the original char and more char from the next batch. In one embodiment, this repeats 5 times, after which the vacuum pump 28 pulls all the char into the char storage chamber 18. In other embodiments, the number of batches is no more than will result in the pyrolysis chamber 10 being filled to below the inlet. In other words, the combined batches of char and the blackwater slurry of the next batch can't fill past the top of the pyrolysis chamber 10.

In some embodiments, the batches are run from the blackwater storage tank to the pyrolysis chamber on a once-a-day basis. In other embodiments, the blackwater is treated following a predetermined number of uses of the toilet. For example, a batch could be run from the blackwater storage tank to the pyrolysis chamber after every third use of the toilet.

In another embodiment, the blackwater tank includes a sensor for determining how full the tank is, and a batch is run through the pyrolysis chamber every time the storage tank reaches a certain percentage of full. For example, a batch could be run every time the storage tank reaches seventy-five percent full. The system can be programmed by the user as to the percentage of full they would like each batch run at, additionally, a user could manually run a batch.

Now referring to FIG. 7, FIG. 7 is an isometric view of a recreational vehicle with a system 200 that may be used in one embodiment of the present invention. A toilet 72 feeds a blackwater storage tank 32. The blackwater is passed into a system 200 for treating blackwater, described in conjunction with FIGS. 2-6. Treated water is returned from the system 200 to the toilet 72 to act as flush water.

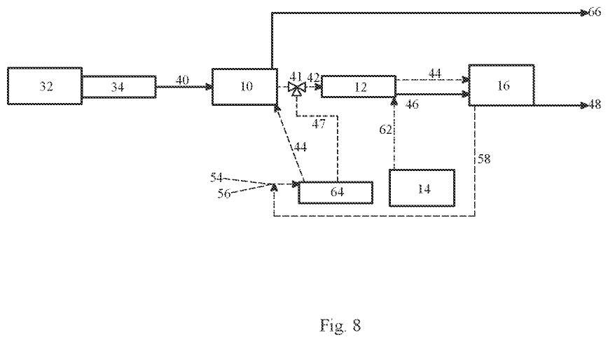

FIG. 8 is a block diagram of a method for treating blackwater that may be used in one embodiment of the present invention. A blackwater slurry 40, such as would be produced by a toilet, is stored in a blackwater tank 32 and is pumped from the blackwater tank by a macerator pump 34 into a pyrolysis chamber 10. The blackwater slurry 40 consists of blackwater solids, water, and volatiles. The volatiles are primarily bound up in the solids. The pyrolysis chamber 10 is heated by flames 44 produced by a burner 64, the burner 64 burning propane 54 with air 56 and leftover volatiles 58. The heat boils off water as steam, as well as some volatiles, which leaves through valve 41 into steam condenser 12. Once the temperature of the pyrolysis chamber passes the boiling point of steam, the valve 41, a three-way valve, switches and lets any leftover steam and volatiles produced by pyrolysis of the solids out as stream 47, which is sent to burner 64. The blackwater solids are heated until they are pyrolyzed into a char 66 that is intermittently removed from of the pyrolysis chamber 10, preferably by a vacuum.

A condensing heat exchanger 12 cools the stream 42 so that the steam and at least a portion of the separated volatiles condense. An ozone generator 14 feeds ozone 62 into the condensing heat exchanger 12, the ozone acting as a water-clarifying chemical that destroys at least a portion of the separated volatiles, thereby removing odor-causing compounds and clarifying the water so that it is clear and not colored. The resultant clarified water stream 46 and any leftover volatiles and ozone 44 are passed from the condensing heat exchanger 12 into a holding tank 16. Any leftover volatiles and excess ozone are recycled as leftover fumes 58 to the burner 64 for destruction. The water in the holding tank 16 may be used as flush water for a toilet feeding the blackwater tank 32.

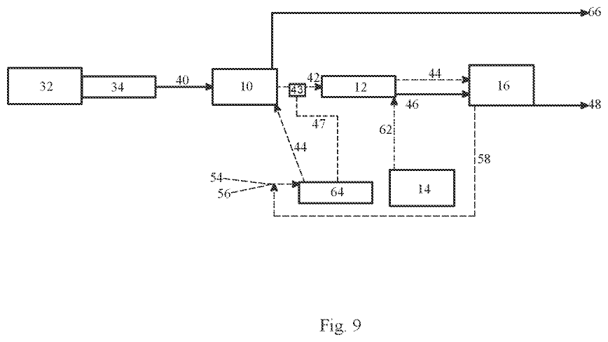

FIG. 9 is a block diagram of a method for treating blackwater that may be used in one embodiment of the present invention. A blackwater slurry 40 is stored in a blackwater tank 32 and is pumped from the blackwater tank by a macerator pump 34 into a pyrolysis chamber 10. The blackwater slurry 40 consists of blackwater solids, water, and volatiles. The volatiles are primarily bound up in the solids. The pyrolysis chamber 10 is heated by flames 44 produced by a burner 64, the burner 64 burning propane 54 with air 56 and leftover volatiles 58. The heat boils off water as steam and some volatiles. Once the temperature of the pyrolysis chamber passes the boiling point of steam, the steam is mostly gone and the blackwater solids are heated until they are pyrolyzed into a char 66 that is intermittently vacuumed out of the pyrolysis chamber 10. This produces the balance of the volatiles. The steam and volatiles pass as stream 42 through an oil trap (condenser) 43 that is at a temperature to condense out heavier volatiles, such as fatty acids, which are passed as stream 47 into the burner.

A condensing heat exchanger 12 cools the stream 42 so that the steam and the separated volatiles condense. An ozone generator 14 feeds ozone 62 into the condensing heat exchanger 12, the ozone acting as a water-clarifying chemical that destroys at least a portion of the separated volatiles, thereby removing odor-causing compounds and clarifying the water so that it is clear and not colored. The resultant clarified water stream 46 and any leftover volatiles and ozone 44 are passed from the condensing heat exchanger 12 into a holding tank 16. Any leftover volatiles and excess ozone are recycled as leftover fumes 58 to the burner 64 for destruction. The water in the holding tank 16 may be used as flush water for a toilet feeding the blackwater tank 32.

In some embodiments, the condensing heat exchanger is an indirect contact heat exchanger that cools the steam and volatiles by indirect contact with air flow across an external surface of the condensing heat exchanger. In other embodiments, the condensing heat exchanger is an indirect contact heat exchanger that cools the steam and volatiles by indirect contact with a cooling liquid.

Where the water-clarifying chemical is a gas, in those embodiments, the gas is passed into the contaminated water stream through a bubbler in the condensing heat exchanger.

Heating the slurry to remove the water as steam reduces the unpleasant smell of the blackwater, however the volatiles that are produced along with the steam still have an unpleasant odor. To further reduce the unpleasant odor in the steam and then the reused water, the volatiles can be separated. Most of the volatile compounds produced during pyrolysis have higher boiling points than water. To separate the water from the volatiles the pyrolysis chamber is heated to 100° C. This temperature is maintained until no more steam is produced, at which point a shut off valve to the condenser is closed. After the shut off valve to the condenser is closed the pyrolysis chamber continues heating. As the temperature increases the volatiles are separated from the blackwater slurry. Many of the volatiles have boiling points above 150° C. The volatiles pass through a release tube. This outlet tube directs the volatiles to the burner, where they are burned with the fuel heating the pyrolysis chamber.

In some alternative embodiments, another method is used to separate the gases that come from the pyrolysis chamber. While the chamber is approximately or less than 100° C., the steam produced is sent to a condenser as usual. This condensate would be very low in volatiles. Then, when the water has been boiled off and the temperature begins to rise past about 110° C., the condenser is bypassed and the volatiles (that tend to evaporate closer to 150° C. or above) are sent directly to the flame to combust. This leaves the condensed water with decreased contaminants and allows less ozone to be used and increases the effectiveness of the ozone treatment. In some embodiments where the steam and volatiles are separated, the water clarifying treatment is not used.

In another embodiment, the steam and volatiles pass through an oil trap before the condenser. The oil trap is a condenser that is at a temperature to primarily condense and remove the volatiles, such as fatty acids. The steam and lighter volatiles, such as syngas produced by pyrolysis, would pass through to the steam condenser. The steam would then condense as above. The syngas and other aromatic gases that didn't condense in the steam condenser would still be sent to the flame for combustion. In one embodiment, the oil trap condensate would also be combusted. In another embodiment, the oil trap would be periodically emptied.

In another embodiment, ozone is added before the pyrolysis chamber as well as in the condenser.

The invention has been described with reference to various specific and preferred embodiments and techniques. Nevertheless, it is understood that many variations and modifications may be made while remaining within the spirit and scope of the invention.

What is claimed is:

1. A method for treating blackwater, comprising:
providing a pyrolysis chamber and a condensing heat exchanger;
passing a blackwater slurry, comprising blackwater solids, water, and volatiles, into the pyrolysis chamber;
heating the blackwater slurry to produce steam, to separate at least a portion of the volatiles, and to pyrolyze the blackwater solids, the steam and the separated volatiles passing out of the pyrolysis chamber;
cooling the steam and the separated volatiles in a condensing heat exchanger, condensing at least a portion of the steam and at least a portion of the separated volatiles as a contaminated water stream;
adding a water-clarifying chemical into the contaminated water stream that reacts with the separated volatiles, resulting in a treated water stream.

2. The method of claim 1, wherein the water-clarifying chemical is ozone provided from an ozone generator.

3. The method of claim 2, wherein untreated volatiles and excess ozone are passed into an air/fuel gas mixture and combusted to heat the pyrolysis chamber.

4. The method of claim 1, wherein pyrolyzing the blackwater solids produces a second portion of volatiles that mix with the separated volatiles.

5. The method of claim 1, wherein the water-clarifying chemical is a chlorine-based chemical selected from the group consisting of chlorine gas, trichloro-s-triazinetrione, sodium hypochlorite, calcium hypochlorite, lithium hypochlorite, chlorinated isocyanurates, and hypochlorous acid.

6. The method of claim 1, wherein heating the blackwater slurry further produces char from the blackwater solids.

7. The method of claim 1, further comprising operating the pyrolysis chamber in batches, the initial batch producing an initial amount of char in the pyrolysis chamber and each subsequent batch producing an additional amount of char in the pyrolysis chamber.

8. The method of claim 7, further comprising vacuuming the char out of the pyrolysis chamber after a number of batches.

9. The method of claim 8, wherein the number of batches is less than the number of batches where the combined char and blackwater slurry would fill the pyrolysis chamber above an inlet level.

10. The method of claim 1, wherein the blackwater slurry is fed into the pyrolysis chamber by a macerator pump.

11. A system for treating blackwater, comprising:
a pyrolysis chamber configured to receive a blackwater slurry, comprising blackwater solids, water, and volatiles;
the pyrolysis chamber further configured to heat the blackwater slurry, thereby producing steam, separating at least a portion of the volatiles, and pyrolyzing the blackwater solids, passing the steam and the separated volatiles out of the pyrolysis chamber;
a condensing heat exchanger configured to receive the steam and separated volatiles and condense the steam and at least a portion of the separated volatiles as a contaminated water stream;
the condensing heat exchanger further configured to add a water-clarifying chemical into the contaminated water stream, wherein the water-clarifying chemical reacts with the separated volatiles, resulting in a treated water stream.

12. The system of claim 1, further comprising an ozone generator that is configured to provide ozone as the water-clarifying chemical to the condensing heat exchanger.

13. The system of claim 12, wherein the pyrolysis chamber is heated by combustion of an air/fuel gas mixture and wherein untreated volatiles and excess ozone are passed into the air/fuel gas mixture and thereby combusted.

14. The system of claim 11, wherein the water-clarifying chemical is a chlorine-based chemical selected from the group consisting of chlorine gas, trichloro-s-triazinetrione, sodium hypochlorite, calcium hypochlorite, lithium hypochlorite, chlorinated isocyanurates, and hypochlorous acid.

15. The system of claim 11, wherein heating the blackwater slurry further produces char from the blackwater solids.

16. The system of claim 11, wherein the pyrolysis chamber is configured to operate in batches, the initial batch producing an initial amount of char in the pyrolysis chamber and each subsequent batch producing an additional amount of char in the pyrolysis chamber.

17. The system of claim 16, further comprising a vacuum that vacuums the char out of the pyrolysis chamber after a number of batches.

18. The system of claim 17, wherein the number of batches is less than the number of batches where the combined char and blackwater slurry would fill the pyrolysis chamber above an inlet level.

19. The system of claim 11, further comprising a macerator pump that feeds the blackwater slurry into the pyrolysis chamber.

20. A system for treating blackwater, comprising:
a pyrolysis chamber configured to receive a blackwater slurry, comprising blackwater solids, water, and volatiles;
the pyrolysis chamber further configured to heat the blackwater slurry, thereby producing steam, and pyrolyzing the blackwater solids, passing the steam out of the pyrolysis chamber;
a condensing heat exchanger configured to receive the steam and condense the steam;
wherein the pyrolysis chamber is configured to heat the slurry to evaporate the water in the slurry passing the water into the condensing heat exchanger;
wherein once the steam has passed into the condensing heat exchanger the slurry is further heated, and volatiles are separated from the slurry, and the separated volatiles are sent to the burner to be burned with the fuel heating the pyrolysis chamber.
